(19) United States
(12) Patent Application Publication
(10) Pub. No.: US 2013/0298790 A1
(43) Pub. Date: Nov. 14, 2013

(54) Printing system

(71) Applicant: Hewlett-Packard Development Company, LLP, (US)

(72) Inventors: Raimon Castells, Barcelona (ES); David Claramunt, Sant Esteve Sesrovires (BCN) (ES); Francisco Javier Rodriguez, Mataro (ES)

(73) Assignee: Hewlett-Packard Development Company, LLP, Houston, TX (US)

(21) Appl. No.: 13/849,849

(22) Filed: Mar. 25, 2013

Related U.S. Application Data
(62) Division of application No. 12/510,043, filed on Jul. 27, 2009, now abandoned.

(51) Int. Cl. B41F 3/58; F16H 37/08

(52) U.S. Cl. CPC B41F 3/58; F16H 37/0813
USPC 101/407.1; 101/483; 475/220

(57) ABSTRACT

Print system, having two substrate roll supports for mounting substrate rolls, a drive assembly arranged to rotate substrate rolls, and a transmission arranged to transmit a torque from the drive assembly to the substrate roll supports so that during use the torque acting on each substrate roll is approximately equal.

### BACKGROUND OF THE INVENTION

Large format printers are designed to print on relatively large substrates, for example substrate processing widths may range from 2,5 to 5 meters. These large substrates are typically provided in rolls, to be mounted on a spindle. The substrates may be provided in standard widths. In many cases, the width of the roll may be substantially less than the width of the printer, for example the width may be 1 or 1,5 meter. In such cases a significant part of the available printing width is not used.

To increase the productivity of a printer two substrates can be processed at the same time, i.e. printed in parallel. To allow two substrates to be printed in parallel, usually the printer needs to be modified.

One of the difficulties to overcome when printing, and especially when printing in parallel, is to maintain sufficient substrate tension. When the substrate is wound or unwound for printing, the tension of the unwound part of the substrate has to be controlled relatively precisely to allow for a quality print onto the unwound part. When the tension is not adequately controlled, skew, wrinkling and/or folding, etc. may occur, which may lead to relatively poor image quality or even ink smearing on the substrate.

When printing two substrates in parallel, also the tension in both substrates has to be controlled in parallel. This is generally more difficult than controlling the tension of a single substrate. When one mounted substrate roll has a different outer diameter than the other mounted substrate roll, a mounting of both substrate rolls onto the same spindle could cause damage to the print because the substrates would wind and unwind at different speeds and one substrate might not have sufficient tension.

A solution for parallel printing that has been applied is duplicating the drive system in the printer. The motor, transmission and spindle are duplicated. In one known system two parallel spindles are applied so that the substrate rolls extend in parallel on different spindles. In another example, the spindles may be aligned co-axially so that the substrates extend co-axially. In both cases the drive systems need to be calibrated so as to wind and unwind the roll at equal linear speeds. In both cases customizing the printer for parallel printing involve significant complexity, costs and investments.

Another known example of a parallel printing system applies two bottom carrier rolls extending in parallel to support two substrate rolls placed co-axially on the parallel bottom carrier rolls. By rotating the bottom carrier rolls, both substrate rolls are rotated so that the outside diameters of the rolls have an equal linear speed. This would allow a sufficient tension of both substrates. The bottom carrier rolls may have a rubber outside surface to allow for enough grip on the substrate rolls for rotation and maintaining a required tension in the substrate for printing. A disadvantage of this system is that the bottom carrier rolls sometimes damage the surface of the substrate. Also the substrate tension may be limited or difficult to control. A relatively complex, cost and time consuming operation is necessary to apply the bottom carrier rolls in a printer, oftentimes having poor image quality results.

### BRIEF DESCRIPTION OF THE DRAWINGS

For the purpose of illustration, certain embodiments of the present invention will now be described with reference to the accompanying diagrammatic drawings, in which:

FIG. 1 a perspective view of a print system;

FIG. 2 shows a schematic cross sectional view of a part of a print system;

FIG. 3 shows a perspective, front view of a differential and substrate roll support;

FIG. 4 shows a more detailed view of the differential of FIG. 3 in perspective,

FIG. 5 shows a flow chart of a method of parallel printing.

### DETAILED DESCRIPTION

In the following detailed description, reference is made to the accompanying drawings. The embodiments in the description and drawings should be considered illustrative and are not to be considered as limiting to the specific embodiment of element described. Multiple embodiments may be derived from the following description through modification, combination or variation of certain elements. Furthermore, it may be understood that also embodiments or elements that may not be specifically disclosed may be derived from the description and drawings.

In this description, a substrate roll may comprise a wound substrate. The substrate may comprise a roll part, which is the wound part, and an unrolled part, which may be referred to as the unwound part. The wound part may be essentially cylindrical. An unwound part of the substrate may comprise a part of the same substrate that is unwound from the roll and that extends from the roll. During a printing process, the unwound part may be printed, dried, presented, measured, etc. The unwound part may extend along a print head or a drying mechanism or the like. It should be understood that during both winding and unwinding, an unwound substrate roll part may be present. The substrate roll may be used several times for making several print outs, each time cutting off the printed substrate and re-using the left over substrate roll until there is nothing or very little left.

The substrate may comprise printable material such as paper, card board, film, foil, textile, fabric, metal, wood, canvas or any other type of printable substrate. The substrate may be flexible so as to allow winding of the substrate.

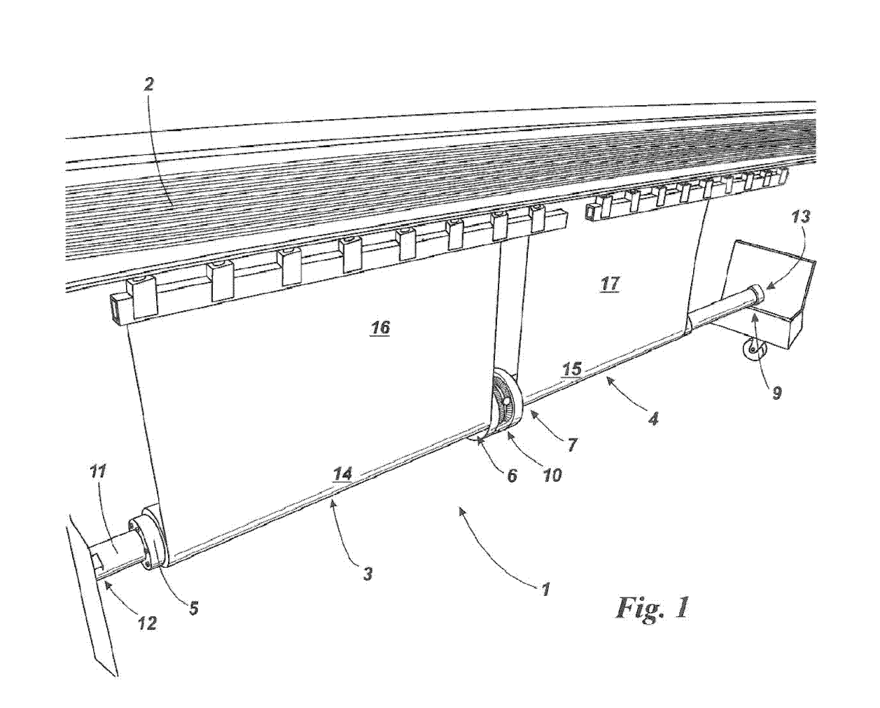

FIG. 1 shows an embodiment of a print system 1. The print system 1 may comprise a large format printer 2, for example for commercial, professional or industrial printing. The print system 1 may comprise two substrate rolls 3, 4, comprising at least partly wound substrates for printing. The substrate rolls 3, 4 may be mounted on the printer 2. The print system 1 may comprise substrate roll supports 5, 6, 7, 8. Each substrate roll 3, 4 may be mounted on two substrate roll supports 5, 6 and 7, 8, respectively. The substrate roll supports 5, 6, 7, 8 may support the substrate rolls 3, 4 near the ends thereof. Each substrate roll 3, 4 may extend between a proximal substrate roll support 6, 7 and a distal substrate roll support 5, 8.

The print system 1 may comprise a drive assembly 9. The drive assembly 9 may be arranged to control a rotation of a spindle for mounting substrate rolls. The drive assembly 9 may be arranged to drive and/or brake a rotation of substrate rolls so as to tension an unwound part of a substrate roll. The drive assembly 9 may comprise an electromotor and a drive control. In certain embodiments, the print system 1 may comprise one drive assembly 9 comprising one electromotor.

The print system 1 may further comprise a transmission 10 that is arranged to transmit a torque from the drive assembly 9 to both substrate roll supports 6, 7. The transmission 10 may be coupled to both substrate rolls 3, 4 for rotating and printing the substrates in parallel, and may be arranged to equally distribute the torque amongst the substrate rolls 3, 4. The transmission 10 may comprise a differential transmission, as will be explained into more detail below.

The print system 1 may comprise a drive spindle 11. The drive spindle 11 may be mounted on the printer 2. The drive spindle 11 may be mounted on the printer 2 like a conventional print substrate roll spindle. The drive spindle 11 may be connected to the drive assembly 9 so that the torque from the drive assembly 9 may be transmitted to the spindle 11. The drive spindle 11 may be connected to the transmission 10 so as to transmit the torque from the drive assembly 9 to the transmission 10.

The drive spindle 11 may be supported in the printer 2 by spindle supports 12, 13. The spindle supports 12, 13 may be arranged to support and facilitate rotation of a conventional print substrate roll spindle.

In this description, the spindle 11, the transmission 10 and the substrate rolls supports 5, 6, 7, 8 may be referred to as a transmission set. For example, the transmission set may be exchanged for a conventional spindle such as normally used in a large format printer. By exchanging the conventional spindle with the transmission set two substrate rolls 3, 4 may be printed in parallel. In one embodiment of the transmission set, the drive spindle 11 may extend through the transmission 10 and/or the substrate roll supports 5, 6, 7, 8. However, different embodiments of a transmission set may be suitable. In another exemplary embodiment, a transmission set may for example include a transmission 10 and two spindles. For example, the transmission 10 may receive a torque from the drive assembly 9 in any manner. The two spindles may receive an equal torque from the transmission 10. The substrate rolls 3, 4 may be mounted on separate spindles.

The transmission and/or substrate roll supports 5, 6, 7, 8 may be supported by the drive spindle 11. The substrate roll supports 5, 6, 7, 8 may be arranged to rotate with respect to the drive spindle 11. The position of the transmission 10 and/or the substrate roll supports 5, 6, 7, 8 on the drive spindle 11 may be chosen in accordance with the widths of the substrate rolls 3, 4.

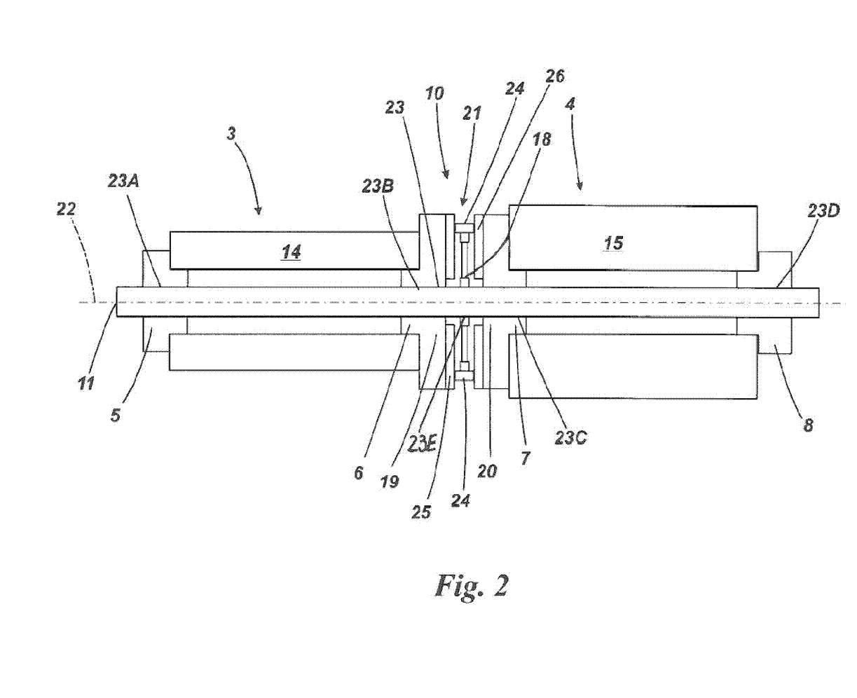

The transmission 10 may be arranged to transmit the torque to the proximal roll supports 6, 7. The proximal roll supports 6, 7 may be connected to the transmission 10. The proximal roll supports 6, 7 may be part of output portions 19, 20 of the transmission 10 (see FIG. 2). The proximal roll supports 6, 7 may transmit the torque of the transmission 10 to the respective substrate rolls 3, 4, while allowing rotation of the respective substrate rolls 3, 4 with respect to the spindle 11. The proximal roll supports 6, 7 may be arranged at a distance from the spindle 11, or may comprise bearings, to allow rotation with respect to the spindle 11.

The distal roll supports 5, 8 may comprise separate roll supports to support the outside ends of the substrate rolls 3, 4. The distal roll supports 5, 8 are arranged to allow rotation of the respective substrate roll 3, 4 with respect to the spindle 11. The distal substrate roll supports 5, 8 may comprise bearings.

A substrate roll 3, 4 may comprise a wound part 14, 15 and an unwound part 16, 17. The width of the substrate roll 3, 4 may for example range from 18 inch or less to 300 inch or more. The width of the substrate roll 3, 4 may be any standard or non-standard width. Two or more substrate rolls 3, 4 that each have a different width may be connected to the transmission 10. The substrates may have any length. Accordingly, two substrate rolls 3, 4 that are mounted in parallel may have different diameters, different widths and different lengths.

For printing a part of the substrate, the substrate roll 3, 4 may need to be partly unwound. The unwound substrate part 16, 17 may for example extend along a print head section of the printer 2. The unwound part 16, 17 may at one end terminate in the substrate roll 3, 4. At another end the substrate may be attached to a driving or guiding arrangement or the like (not shown). The driving or guiding arrangement may for example comprise rolls or the like that aid in maintaining a tension in the substrate. The driving or guiding arrangement may extend on the opposite side of the print heads with respect to the driving assembly 9, or near the print heads.

Rotation of the respective substrate rolls 3, 4 may result in winding and/or unwinding of the substrate rolls 3, 4. The transmission 10 may be provided on both sides, or on either side of the print heads. The transmission 10 and the drive assembly 9 may be arranged to wind the substrate, to unwind the substrate, or both.

The substrate rolls 3, 4 may comprise a shaft around which the substrates may be rolled. The shaft may be a standard or conventional shaft. The shaft may be arranged for connecting the substrates roll 3, 4 to a conventional spindle. The substrate roll supports 5, 6, 7, 8 may be arranged to be coupled to the shaft. In another embodiment, the substrate rolls 3, 4 may comprise rolled substrates without shafts. The substrate roll supports 5, 6, 7, 8 may then be arranged to be coupled directly to the substrate. In an embodiment, the substrate roll supports 5, 6, 7, 8 may comprise a shaft for supporting the substrate roll 3, 4 along its length.

FIG. 2 schematically shows a transmission set, supporting two substrate rolls 3, 4. The transmission 10 may comprise a differential transmission. The transmission 10 may comprise an input portion 18, two output portions 19, 20 and a transmission portion 21. The transmission portion 21 may be arranged to transmit a torque that is received by the input portion 18 to the two output portions 19, 20. The torque acting on each of the output portions 19, 20 may be approximately half of the torque of the input portion 18.

The input portion 18 may receive the torque from the drive assembly 9, via the spindle 11. The input portion 18 may be fixedly connected to the spindle 11. The input portion 18 may be arranged to be fixed to the spindle 11, for example using friction, an adjusting screw, or another suitable mechanism.

The output portions 19, 20 may be arranged to rotate each substrate roll 3, 4. The substrate roll supports 6, 7 may be connected to, or be a part of the output portions 19, 20, so that each substrate roll 3, 4 receives an equal torque via the transmission 10.

The spindle 11 may extend through the transmission 10. The spindle 11 may extend through the input portion 18 and the output portions 19. The input portion 18, the output portions 19, 20 and/or the spindle 11 may have a common axis of rotation 22. The transmission 10 may comprise a through hole 23 for receiving the spindle 11. The substrate roll supports 5, 6, 7, 8 may comprise through holes 23A, 23B, 23C, 23D through which the spindle 11 may extend. The input portion 18 may comprise a through hole 23E through which the spindle 11 may extend.

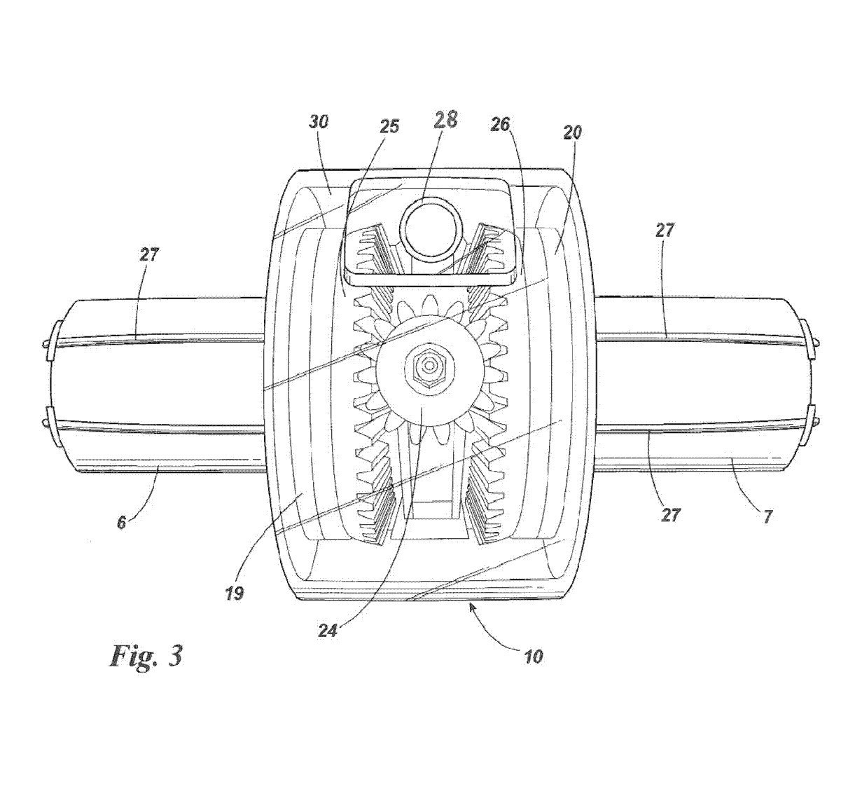

As can be seen in FIGS. 2 and 3, the transmission portion 21 may comprise at least one planet gear 24. The input portion 18 may be associated with two, three, four, or more planet gears 24. The planet gears 24 may move along a circle path having its middle point in the axis of rotation 22. The planet gears 24 may transmit the torque from the spindle 11 to the output portions 19, 20. Each output portion 19, 20 may comprise a sun gear 25, 26. The planet gears 24 may transmit the torque to the two sun gears 25, 26 so that each sun gear 25, 26 has an equal torque. The torque transmitted to each sun gear 25, 26 may be approximately half of the torque that is received through the input portion 18. The sun gears 25, 26 may be part of, or connected to the respective substrate roll supports 6, 7 so that each mounted substrate roll 3, 4 receives an equal torque through the transmission 10.

In different embodiments, the transmission 10 may comprise a mechanical differential, an electrical differential, magnetic differential or another transmission that equally distributes an incoming torque over multiple output portions 19, 20. The transmission portion 21 may comprise magnetic gears, and/or friction gears and/or other suitable transmission mechanisms for distributing an input torque over multiple output portions.

Because of the equal torque acting on each mounted substrate roll 3, 4, during rotation, a tension on the unwound parts 16, 17 of the substrate rolls 3, 4 may be maintained, even if the diameters of the rolls 3, 4 are different. The rotational velocity of each roll 3, 4 may be adjusted so that the torque and the linear velocities of the substrate rolls 3, 4 may be approximately equal. This may allow for parallel winding and/or unwinding of the substrate rolls 3, 4, and/or for parallel printing of the substrates. Misalignment, wrinkling, skew of the substrates may be prevented.

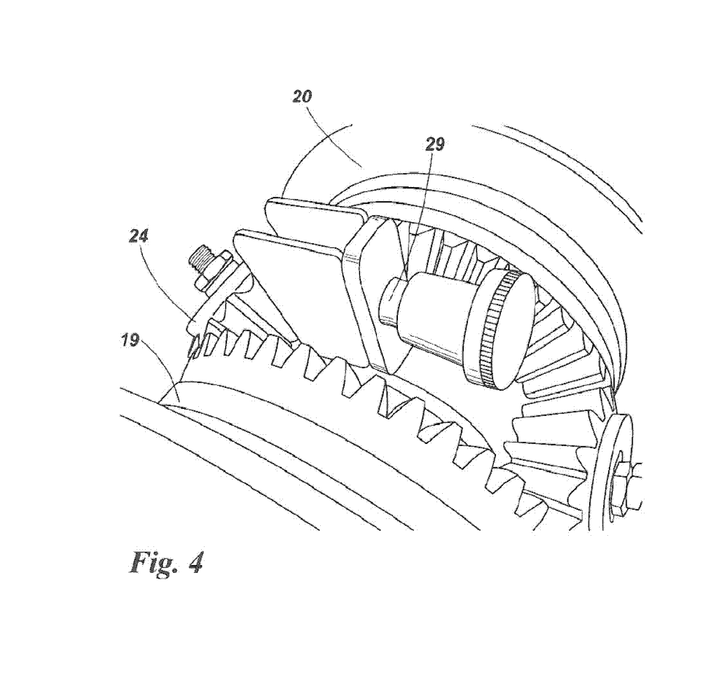

As can be seen from FIGS. 3 and 4, the substrate roll supports 6, 7 may comprise engage members 27 for engaging the inner shaft of the substrate roll 3, 4. The engage members 27 may comprise a resilient and/or elastomeric and/or frictional element for retaining the substrate roll 3, 4 onto the substrate roll support 6, 7. The substrate roll supports 6, 7 may comprise bearings or the substrate roll supports 6,7 may extend at a certain distance from the spindle 11, so as to allow the substrate roll support 6, 7 to rotate with respect to the spindle 11.

The transmission 10 may comprise a blocking mechanism 28 for blocking the transmission 10. The blocking mechanism 28 may be arranged to block the differential transmission, or one or more transmission parts of the transmission 10, for example a planet gear 24 and/or a sun gear 25, 26. In a blocked condition, the spindle, the transmission 10 and the substrate rolls 6, 7 may have the same rotational speed. In a blocked condition both output portions 19, 20 of the transmission 10 may have the same rotational speed. This may be advantageous in particular situations.

On exemplary situation is when the rolls are mounted and the substrate has to be positioned along the print heads. Pulling a substrate from one roll 3, 4, for positioning along the print head, may cause a disadvantageous counter reaction from the other roll 4, 3, when using a mechanical differential transmission that is not blocked. In another example, a situation may arise where just one substrate is tensioned, and on the other side of the transmission 10 the substrate roll 3, 4 is dismounted, empty, or the substrate is not stretched along the print heads. In an unblocked situation, using a differential transmission, the respective output portion 19 that does not receive a counter torque due to a dismounted roll 3, 4, an empty roll, or a tensionless substrate, may rotate relatively fast, because there may be no resistance, while the other output portion 20 and substrate roll 4 would rotate relatively slow, or not at all, because there may be resistance on that side. However, by blocking the transmission 10, both substrate rolls 3, 4 may continue winding and/or unwinding at a relatively controlled speed, relatively unhampered.

As shown in FIG. 4, the blocking mechanism 28 may be arranged to block a planetary gear 24. The blocking mechanism 28 may for example comprise an adjusting screw 29 and/or a spoke or the like arranged to engage and block the planetary gear 24 and/or an axle of the planetary gear 24.

The transmission 10 may comprise a protective housing 30 so as to cover the moving parts. The protective housing 30 may cover at least the gears 24, 25, 26.

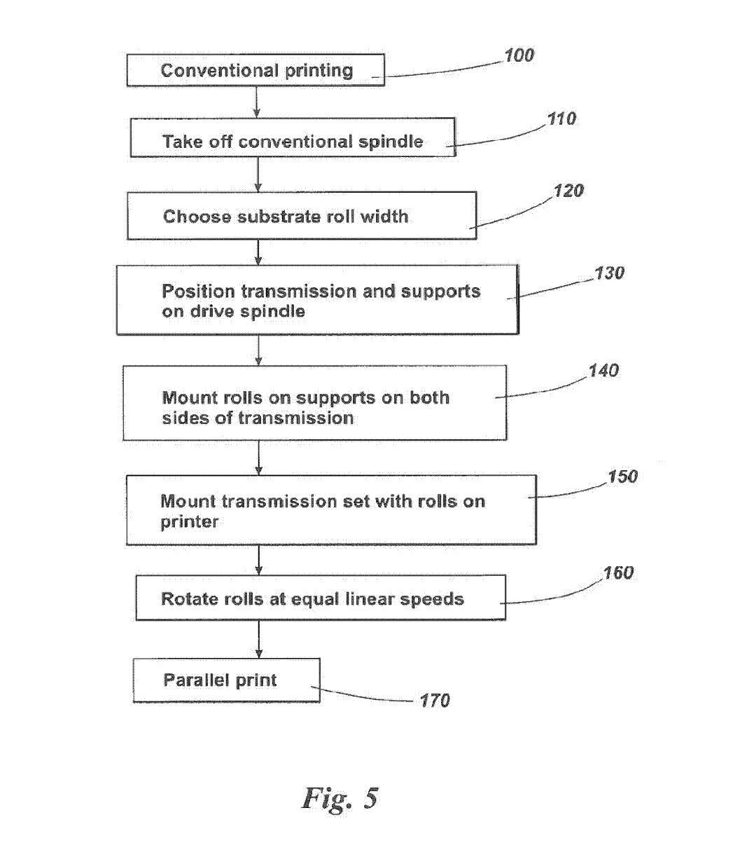

In FIG. 5, a method is shown of printing two substrate rolls 3, 4 in parallel. In step 100 a printer 2 may be used, for example in a conventional manner. The printer 2 may be a conventional or known printer. The printer 2 may be a printer 2 that may be primarily arranged for processing one substrate roll at the same time.

In a particular situation, the printer 2 may be used to print two substrates in parallel. Therefore, a spindle, which may be a conventional spindle, may be taken off in step 110.

In step 120, a user may choose particular lengths and widths for substrates. The width of two substrate rolls 3, 4 may be such that it is possible to fit two substrate rolls 3, 4 between the spindle supports 12, 13 of the printer 2. The substrate rolls 3, 4 may each have a different width.

In step 130, the transmission 10 and the substrate roll supports 6, 7 may be positioned on the spindle 11. The transmission 10 may be positioned on the spindle 11 so that both substrate rolls 3, 4 fit on the spindle 11 on both sides of the transmission 10 and between the spindle supports 12, 13 of the printer 2. Before mounting the substrate rolls 3, 4, the proximal substrate roll supports 6, 7 may be connected to the transmission 10.

In step 140 the substrate rolls 3, 4 may be mounted on the substrate roll supports 6, 7. The substrate rolls 3, 4 may be coupled to the proximal substrate roll supports 6, 7. The distal substrate roll supports 5, 8 may be coupled to the spindle 11 and the distal ends of the substrate rolls 3, 4. In this condition, the spindle 11 may support the transmission 10, the substrate roll supports 5, 6, 7, 8 and the substrate rolls 3, 4, for example approximately as shown in FIG. 2.

In step 150, the assembly of the transmission set and substrate rolls 5, 6, 7, 8 may be mounted onto the printer 2. The spindle 11 may be coupled to the drive assembly 9. The drive assembly 9 may provide for a torque. The spindle 11 may transmit the torque. The transmission 10 may transmit the torque, so that both substrate roll 3, 4 receive an equal torque. This received torque may be approximately half of the total transmitted torque. The approximately equal torque may provide for approximately equal linear speeds of the substrate rolls 3, 4, as indicated by step 160. The unwound parts 16, 17 of the substrate rolls 3, 4 may be wound or unwound at approximately equal linear speeds.

At step 160, if the substrate rolls 3, 4 are of different diameters the rotational speeds of the substrate rolls 3, 4 and/or the substrate roll supports 5, 6 and 7, 8, respectively, may be different.

In step 170, the unwound parts 16, 17 of the substrate rolls 3, 4 may be printed in parallel. Both unwound parts 16, 17 of the substrate rolls 3, 4 may have approximately equal linear velocities so as to conveniently allow quality printing of both substrates at the same time, i.e. in parallel.

In other embodiments, more than one transmission 10 may be applied to parallel print more than two substrate rolls 3, 4. In an embodiment wherein multiple transmissions 10 are applied, the transmission may comprise an electronically controlled differential that may be arranged to distribute the torque amongst three or more substrate rolls 3, 4. An exemplary differential transmission may comprise more than two output portions 19, 20 to distribute an approximately equal torque to more than two substrate rolls 3, 4. The system 1 may allow three, four or more substrate rolls 3, 4 to be printed in parallel.

In one aspect, a method of parallel printing may comprise (i) mounting two substrate rolls 3, 4 having different outside diameters on a printer, (ii) providing a torque within the printer 2, and (iii) transmitting the torque within the printer 2 to both substrate rolls 3, 4 in a proportioned manner so as to allow approximately equal linear speeds of the unwound parts 16, 17 of the substrate rolls.

In a second aspect, a parallel print differential transmission may be provided, which may comprise (i) an input portion 18, (ii) two output portions 19, 20, and (iii) a differential transmission portion 21 arranged to transmit a torque from the input portion 18 to the output portions 19, 20 so that each output portion 19, 20 has an approximately equal torque, wherein each of the two output portions 19, 20 comprises a substrate roll support 6, 7 arranged to rotate and at least partially support a substrate roll 3, 4.

In a third aspect, a print system 1 may be provided, which may comprise (i) at least two substrate roll supports 6, 7 for mounting substrate rolls 3, 4, (ii) a drive assembly arranged 9 to rotate substrate rolls, and (iii) a transmission 10 arranged to transmit a torque from the drive assembly 9 to the substrate roll supports 6, 7 so that during use the torque acting on each substrate roll 3, 4 is approximately equal.

The above description is not intended to be exhaustive or to limit the invention to the embodiments disclosed. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality, while a reference to a certain number of elements does not exclude the possibility having more elements. A single unit may fulfil the functions of several items recited in the disclosure, and vice versa several items may fulfil the function of one unit.

The mere fact that certain measures are recited in mutually different dependent claims does not indicate that a combination of these measured cannot be used to advantage. Multiple alternatives, equivalents, variations and combinations may be made without departing from the scope of the invention.

1. Print system, comprising
two substrate roll supports for mounting substrate rolls,
a drive assembly arranged to rotate substrate rolls, and
a transmission arranged to transmit a torque from the drive assembly to the substrate roll supports so that during use the torque acting on each substrate roll is approximately equal.

2. Print system according to claim 1, wherein the transmission comprises a differential.

3. Print system according to claim 2, wherein the differential comprises
an input portion for connection to the drive assembly, and
two output portions associated with the substrate roll supports.

4. Print system according to claim 2, wherein the substrate rolls are coupled to the differential on opposite sides of the differential.

5. Print system according to claim 1, comprising a drive spindle mounted on the printer and connected to the drive assembly and the transmission so as to transmit the torque from the drive assembly to the transmission.

6. Print system according to claim 5, wherein the drive spindle extends through the transmission.

7. Print system according to claim 6, wherein
the drive spindle extends through the substrate roll supports, and
the substrate roll supports are arranged to rotate with respect to the drive spindle.

8. Print system according to claim 5, wherein the substrate roll supports are arranged to support proximal ends of the respective substrate rolls, and
the print system further comprises two distal substrate roll supports being mounted on the drive spindle so as to be rotated with respect to the drive spindle, for supporting distal ends of the respective substrate rolls, each substrate roll extending between a proximal and a distal substrate roll support.

9. Print system according to claim 5, wherein the print system comprises a large format printer.

10. Print system according to claim 1, wherein the drive assembly comprises a servo controlled electromotor arranged to control the torque of a single spindle.
